(19) United States
(12) Patent Application Publication
(10) Pub. No.: US 2019/0269126 A1
(43) Pub. Date: Sep. 5, 2019

(54) SYSTEM TO PACKAGE AND TRANSPORT FRESH CUT PRODUCE

(71) Applicants: SUBRAMANIAM G. APPAN, LEAGUE CITY, TX (US); MANGALAM LONE, LEAGUE CITY, TX (US)

(72) Inventors: SUBRAMANIAM G. APPAN, LEAGUE CITY, TX (US); MANGALAM LONE, LEAGUE CITY, TX (US)

(21) Appl. No.: 16/419,196

(22) Filed: May 22, 2019

Related U.S. Application Data
(63) Continuation of application No. 15/393,923, filed on Dec. 29, 2016, now abandoned.

(51) Int. Cl. A01N 3/02; B65B 25/02; A01G 5/06; A23B 7/158; B65D 85/50; B65D 81/22; B65B 25/00

(52) U.S. Cl. CPC A01N 3/02; B65B 25/02; A01G 5/06; A23V 2002/00; B65D 85/505; B65D 81/22; B65B 25/001; A23B 7/158

(57) ABSTRACT

A system for packaging and transporting produce is disclosed. The system includes a cup-shaped base having a bottom with side walls extending upward therefrom to a top rim, the bottom having an outer, substantially flat surface and an inner surface opposite the outer surface, and the inner surface and side walls forming an inner space. The system may further include within the inner space one of soil, an absorbent non-organic material or chlorinated water with additives. The system also includes a substantially dome-shaped top configured to rest upon and mate with the top rim. Methods and devices for packaging and transporting produce are also disclosed

### BACKGROUND

### Field of the Disclosure

The present disclosure relates to a system, device and method to package and transport fresh cut produce. The disclosure also provides a packaging system that includes a means to provide hydration and ventilation for the fresh cut produce throughout the supply chain.

### Description of the Related Art

The use of fresh cut produce, particularly herbs, has become popular among home cooks and professional chefs alike. However, challenges have been encountered in packaging and transporting fresh cut produce without compromising freshness of the produce.

Existing packaging systems, including various kinds of packaging for flowers and herbs, do not provide a means for cut stems to remain upright in a hydration medium throughout the supply chain. In many cases, the produce is laid flat on a box or sleeve. This neither provides in-situ hydration for the cut produce nor does it prevent decay of the produce.

U.S. Pat. No. 6,138,828 (Bendix) discloses herb packaging with a vessel or tube partially filled with water. A lid closes the top of the vessel to reduce spillage of the water. The vessel or tube has a curved base that prevents it from independently standing upright. Additionally, a cellophane wrapper is provided about leafy portions of the packaged herbs outside of the vessel.

U.S. Pat. No. 3,552,059 (Moore) discloses a flower base consisting of a brick or mass of water-filled, water-retentive cellular foam or fibrous material, wrapped in a puncturable liner and housed in an outer box, is attached to one end wall of the flower box. The outer box of the flower base has a large cut out portion in one or more walls providing a passageway for inserting cut flower stems through the puncturable liner into the water-soaked brick or mass. The stems are not kept upright throughout the supply chain.

U.S. Pat. No. 4,189,868 (Tymchuck, et. al.) discloses a bag, formed of a plastic material, is inflated with a gaseous medium. A living plant having an absorbent block attached to its root system is placed within the bag in such a manner that the block absorbs moisture which condenses within the bag, and makes it available to the plant. The package does not have a non-tilt and non-spill design, leaving the produce vulnerable during transport.

Each of the above-references is hereby expressly incorporated by reference in its entirety.

The present disclosure improves on the deficiencies of the prior art and provides a system, device and method of transport, which allows for non-tilt, non-spill packaging with in-situ hydration and ventilation.

### SUMMARY OF CERTAIN INVENTIVE ASPECTS

In a first aspect, a system for packaging and transporting produce is provided. In some embodiments, the system includes, for example, a cup-shaped base having a bottom with side walls extending upward therefrom to a top rim, the bottom having an outer substantially flat surface and an inner surface opposite the outer surface, and the inner surface and side walls forming an inner space. In some embodiments, the system includes means for hydration placed within the inner space to provide in-situ hydration to produce and a substantially dome-shaped top configured to rest upon and mate with the top rim.

In some embodiments, the means for hydration is chlorinated water that may also include one or more additives or preservatives. In some embodiments, the one or more additives or preservatives are selected from the group including citric acid, sugar, and bleach. In some embodiments, the one or more additives or preservatives are selected from the group including bactericides, fungicides, precipitation agents, surfactants, and substrates that can be metabolized. In some embodiments, the means for hydration is soil. In some embodiments, the means for hydration is an absorbent non-organic material. In some embodiments, the absorbent non-organic material is a water-soaked brick or mass. In some embodiments, absorbent non-organic material such as Rockwool or soil-less media such as Canadian moss may be used. In some embodiments, the means for hydration further includes chlorinated water. In some embodiments, the means for hydration further includes water having a chloramine level between about 0.50 ppm and about 3.80 ppm. In some embodiments, the means for hydration further includes one or more additives.

In some embodiments, the top rim is substantially circular. In some embodiments, the side walls extend upward from the bottom to form a substantially cylindrical shape. In some embodiments, the side walls extend upward from the bottom in an angled fashion such that the inner space is smaller at the bottom and larger at the top rim. In some embodiments, the cup-shaped base is formed of plastic. In some embodiments, the substantially dome-shaped top is formed of plastic. In some embodiments, the substantially dome-shaped top includes an aperture. In some embodiments, the aperture is substantially circular. In some embodiments, the aperture has a diameter between about 2 cm and about 2.5 cm. In some embodiments, the substantially dome-shaped top has a top lip and the top rim has a bottom lip such that the top lip mates with the bottom lip. In some embodiments, the produce is selected from the group including flowers, basil, bay leaves, chives, cilantro, dill, lemongrass, marjoram, mint, oregano, parsley, rosemary, sage, tarragon, and thyme

In another aspect, a container to package and transport sanitized produce is provided. The container may include, for example, a cylindrical bottom with a flat base to allow it to stand vertically, a dome top including an aperture fitted tightly over the bottom and a hydration medium positioned inside the container. In some embodiments, the hydration medium uses chlorinated water to provide in-situ hydration.

In some embodiments, either the cylindrical bottom or the dome top is formed of a clear plastic material. In some embodiments, the aperture on the dome top has a diameter between about 2 cm and about 2.5 cm. In some embodiments, the hydration medium is between about 1.5 cm and about 2.5 cm in thickness. In some embodiments, the diameter of the cylindrical bottom varies in a transverse direction such that the diameter is greatest at the top of the cylindrical bottom and smallest at the base.

In another aspect, a method for packaging and transporting produce while retaining antioxidants and freshness is provided. The method may include, for example, placing stems of fresh cut produce in a standing position in a hydration medium in a container having a bottom portion with a substantially flat surface and a top portion, attaching the top portion to the bottom portion, allowing the stems from fresh cut produce to be ventilated through an aperture on the top of the container, and providing continuous hydration for the stems from fresh cut produce throughout the supply chain.

In some embodiments, the continuous hydration is provided with chlorinated water to provide in-situ hydration. In some embodiments, the method further includes sanitizing the cut stems. In some embodiments, placing cut stems in a standing position comprises placing the cut stems in a hydration medium that has a thickness between about 1.5 cm and about 2.5 cm.

### BRIEF DESCRIPTION OF THE DRAWINGS

The features and advantages of the system and method to package and transport fresh cut produce described herein will become more fully apparent from the following description and appended claims, taken in conjunction with the accompanying drawings. These drawings depict only several embodiments in accordance with the disclosure and are not to be considered limiting of its scope. In the drawings, similar reference numbers or symbols typically identify similar components, unless context dictates otherwise. The drawings may not be drawn to scale.

FIG. 1 is a perspective view of one embodiment of the system to package and transport fresh cut produce. The system comprises a dome-shaped top and a cup-shaped bottom.

FIG. 2A is a top view of one embodiment of the system and method to package and transport fresh cut produce.

FIG. 2B is a bottom view of one embodiment of the system and method to package and transport fresh cut produce.

FIG. 3 is a flow diagram explaining the sequence of operations for the method to package and transport fresh cut produce.

### DETAILED DESCRIPTION OF CERTAIN PREFERRED EMBODIMENTS

The following discussion presents detailed descriptions of the several embodiments a system and method for packaging and transporting fresh cut produce. These embodiments are not intended to be limiting, and modifications, variations, combinations, etc., are possible and within the scope of this disclosure.

Disclosed herein are a system and method for packaging and transporting fresh cut produce throughout the supply chain by providing a dome shaped container with means for in-situ hydration and ventilation to arrest senescence. As used herein, the term “supply chain” refers to every step of the process that occurs between initial harvesting and packaging of the fresh cut produce through the final use of the produce by the consumer. Harvesting may occur at a farm or garden. The supply chain may also include a supermarket or other place of sale in addition to a final location at a commercial establishment (such as a restaurant) or a consumer's home. Although this disclosure primarily discusses a system and method for packaging and transporting fresh cut produce, it is not intended that this disclosure be limited to only that example—the system and methods described herein may be used to package and transport other fresh agricultural products.

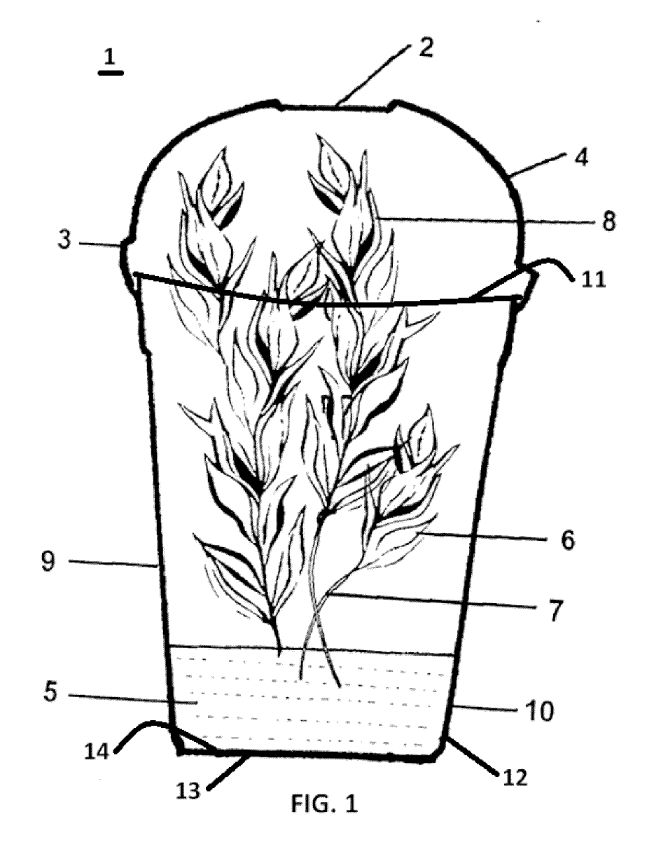

FIG. 1 is a perspective view of one embodiment of the system 1 to package and transport fresh cut produce. The system 1 includes a substantially dome-shaped top 4 and a cup-shaped base 10. The system 1 can be used to package and transport pre-sanitized, fresh cut produce 8. Fresh cut produce 8 may include, for example, fresh cut herbs or fresh cut flowers or any produce having a stem. Fresh cut herbs may include, for example, basil, bay leaves, chives, cilantro, dill, lemongrass, marjoram, mint, oregano, parsley, rosemary, sage, tarragon, and thyme. Although the system 1 can be used to package and transport fresh cut produce, this is intended as only one example of how the system 1 may be used. In more general terms, the system 1 may be useable to package and transport a variety of products including fresh cut stems 7, including flowers. Suitable flowers may include any flower or shrub that has a stiff enough stem to penetrate the means for hydration 5 and stand upright. In one embodiment, the substantially dome-shaped top 4 of the system 1 is made of a plastic material. In some embodiments, the plastic material is substantially clear to allow a visual quality check of the fresh cut produce 8 (or flowers or other materials) housed therein. In other embodiments, the substantially dome-shaped top 4 of the system 1 can be made of any suitable material including Styrofoam or cardboard. When cardboard is used as the material, the cardboard may be waxed. In one embodiment, the cup-shaped base 10 of the system 1 is made of a plastic material. In some embodiments, the plastic material is clear to allow a visual quality check of the fresh cut produce 8 (or flowers or other materials) housed therein. In other embodiments, the cup-shaped base 10 of the system 1 can be made of any suitable material including Styrofoam or cardboard. In the event that cardboard is used as the material for the cup-shaped base 10, the cardboard may be waxed so that it may be configured to hold the hydration material. In some embodiments, the dome-shaped top 4 is formed of a first material and the cup-shaped base 10 is formed of a second material. For example, the first material may be plastic (or a clear plastic) and the second material may be Styrofoam or cardboard. Or, in a first alternative, the first material is Styrofoam and the second material is cardboard or plastic. Or, in a second alternative, the first material is cardboard and the second material is plastic or Styrofoam. In other embodiments, the dome-shaped top 4 and the cup-shaped base 10 are formed of the same material.

In the illustrated embodiment, the system 1 comprises a cup-shaped base 10 having a bottom 12 with side walls 9 extending upward to a top rim 11. In some embodiments, the top rim 11 is substantially circular, as illustrated in FIG. 1. The bottom 12 of the cup-shaped base 10 of the system 1 comprises an outer, substantially flat surface 13 and an inner surface 14 opposite the outer surface. The inner surface 14 and side walls 9 form an inner space 6. The substantially flat outer surface 13 of the cup-shaped base 10 is configured to prevent the system 1 from tilting or falling during transport. In some embodiments, as illustrated in FIG. 1, the side walls 9 of the cup-shaped base 10 extend upward from the bottom 12 in an angled fashion such that the inner space 6 is smaller at the bottom and larger at the top rim 11. In other embodiments, the side walls 9 may extend upward in a straight fashion to give the cup-shaped base 10 a substantially cylindrical shape.

A means for hydration 5 is placed within the inner space of the cup-shaped base 10 to provide in-situ hydration to the fresh cut produce 8. The means for hydration 5 is configured to prevent the cut stems 7 of the fresh cut produce 8 from decaying and to preserve freshness. In the illustrated embodiment, the means for hydration 5 comprises soil. As used herein, the term “soil” may include, but is not limited to, potting soil, clay, and mulch.

Plants need light, nutrients, and water to sustain life as they grow. When stems or produce are clipped from a plant and harvested, a physiological process called senescence sets in. This leads to decline in the appearance, freshness, and fragrance, and/or in the loss of antioxidants in the cut stems or cut produce. Therefore, the illustrated embodiment of FIG. 1 is configured to minimize senescence for a period of two (2) weeks, which is the shelf life requirement for merchandizing fresh cut herbs in supermarkets. In some embodiments, the system may minimize senescence for a period of about 1, 2, 3, 4, 5, 6, 7, 8, 9, 10, 11, 12, 13, 14, 15, 16, 17, 18, 19, or 20 days or any average range between those values. Some embodiments of the present disclosure are configured to minimize senescence by providing water to the fresh cut stems or produce. The other two factors—light and nutrients—although essential for growth, are not considered critical for the goal of minimizing senescence during a two week window. Thus, one object of the system 1 illustrated in FIG. 1 is to provide hydration to fresh cut produce 8 throughout the supply chain from farm to supermarket to the customer's home.

In the illustrated embodiment, the system 1 is configured to provide hydration without the use of any preservation additives. Because the system 1 is configured to minimize senescence for the duration of a two week window, the means for hydration 5 in the illustrated embodiment of FIG. 1 may include municipal drinking water. In some embodiments, municipal drinking water may include various approved levels of chloramine (chlorine and ammonia) to control microbes.

### Example 1

In Example 1, the municipal drinking water was obtained from League City, Tex. Chloramine levels in the municipal drinking water were measured. Average chloramine levels were measured at 1.89 parts per million (ppm) and generally ranged between 0.50 ppm to 3.80 ppm, according to the Water Quality Report 2015 of City of League City, Tex., which is hereby incorporated by reference in its entirety.

The present embodiment illustrated in FIG. 1 is configured to use water containing levels of chloramine between 0.50 ppm to 4 ppm as the means for hydration 5 or levels of chloramine as described in Example 1. In other embodiments, the water has a level of chloramine of about 0.5, 0.6, 0.7, 0.8, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0 ppm or any range in between those values. In some embodiments, the water has a level of about 1.89 ppm chloramine. There is no significant adverse effect on plants at “low” levels of chloramine (between about 0.5 and 3.8 ppm). For example, a study by Australia's Urban Water Research Association, which is hereby incorporated by reference in its entirety, concluded that “[i]t seems unlikely that the use of chloraminated water has adverse effect on plants, whether the water is applied directly to the soil or as an aerial spray.” The chloramine in the means for hydration 5 will have a significant beneficial effect in controlling microbes. Therefore, chloraminated city drinking water, rather than pure distilled water, may be used in the present embodiment of the system 1.

In other embodiments, the means for hydration 5 may include soil, an absorbent non-organic material, or chlorinated water containing additives or preservatives. Absorbent non-organic material includes, but is not limited to, a water soaked brick or mass, a Styrofoam block, cloth, and a cardboard block. In some embodiments, absorbent non-organic material such as Rockwool or soil-less media such as Canadian moss may be used. In some embodiments chlorinated water containing additives is used as the means for hydration 5. Many additives may be beneficial when added to water and administered to cut stems or produce, especially for cut flowers. These additives may include, but are not limited to: bactericides and fungicides to reduce bacterial or fungal degradation; precipitation agents such as aluminum sulfate to cause settling of dirt particles in the water to prevent blocking of water absorption channels; surfactants to enhance water absorption; and/or substrates that can be metabolized (such as mono- or di-saccharides) to promote extended life to cut stems or produce.

The system 1 includes a substantially dome-shaped top 4 configured to rest upon and mate with the top rim 11 of the cup-shaped base 10. In the illustrated embodiment, the dome-shaped top 4 is a semi-spherical shape. However, in other embodiments, the dome-shaped top might be a frustum, a conical shape, a pyramidal shape, a cubical shape, a prism-like shape, or the like. In the illustrated embodiment, the dome-shaped top 4 of the system 1 includes a lip 3 to mate with the cup-shaped base 10. In other embodiments, the dome-shaped top 4 may mate with the cup-shaped base 10 in a different manner such as a seal placed over the edges of the dome-shaped top 4 and the cup-shaped base 10. The lip 3 on the dome-shaped top fits tightly and securely over the cup-shaped base 10 to facilitate a no-spill design for the system 1.

In the illustrated embodiment, the dome-shaped top 4 of the system 1 includes an aperture 2. In other embodiments the dome-shaped top may comprise of a plurality of apertures. In the illustrated embodiment, the aperture 2 in the dome-shaped top 4 is circular. In other embodiments, the one or more apertures 2 in the dome-shaped top may be of any shape. For example, acceptable shapes in other embodiments may include, but is not limited to, squares, rectangles, triangles, pentagons, hexagons, or the like. In other embodiments, the cup-shaped base 10 of the system 1 may include one of more apertures 2 of any shape. In one embodiment the aperture 2 has a diameter between about 2 centimeters and about 2.5 centimeters. In other embodiments, the diameter of the aperture 2 may be less than, greater than, about, or between any of 0.25, 0.5, 1, 1.25, 1.5, 1.75, 2, 2.25, 2.5, 2.75, 3, 3.25, 3.5, 3.75, 4, 4.25, 4.5, 4.75, 5, 5.25, 5.5, 5.75, 6, 6.25, 6.5, 6.75, 7, 7.25, 7.5, 7.75, 8, 8.25, 8.5, 8.75, 9, 9.25, 9.5, 9.75, or 10 centimeters, The aperture 2 may be configured to provide ventilation, and allow the consumer to check the aroma of the fresh cut produce (or flowers or other materials) 8 housed therein.

In some embodiments, the fresh cut produce 8 is sanitized before being placed in the means for hydration 5. As used herein, the term “sanitize” means to adequately treat food-contact surfaces by a process that is effective in destroying vegetative cells of microorganisms of public health significance, as defined in 21 CFR 110.3(o) (CFR 2000b), which is hereby incorporated by reference in its entirety. In one embodiment, the fresh cut produce 8 is sanitized using a stable peroxycompound chemistry as sanitizing agent which disinfects on contact, approved by the Organic Material Review Institute (OMRI) for organic processing, and leaving minimal (or zero) toxic residues on the herbs to be packaged. Suitable peroxycompounds (or peroxy compounds) are compounds containing the group —OO—. In general, a peroxycompound that may be used as a sanitizing agent would be suitable for use. Some general examples of peroxycompounds may include hydroperoxides, which contain an —OOH group, peroxy acids, which are represented by the generic formula RCO—OOH, or diacyl peroxides, which are represented by the general formula RCO—OO—COR. Washing some fresh cut produce 8, such as fresh cut herbs, before packaging may negatively impact shelf life. Thus, in the present embodiment, sanitizing agents based on peroxycompound chemistry may be sprayed on to disinfect the fresh cut produce 8 on contact, avoiding the washing process. For example, a waxy layer known as the cuticle covers herb leaves, reducing the rate of water loss from the leaf surface. Washing fresh cut herbs may breakdown the cuticle layer, especially if surfactants are used. This may also expose the tissue of the fresh cut herbs to microbial decay. Sanitizing agents based on peroxycompound chemistry, on the other hand, evaporate after being sprayed on, leaving no toxic residue. These agents are also approved for organic processing (OMRI listed), and approved for use on fresh cut herbs in particular.

In other embodiments, the fresh cut produce 8 maybe sanitized by using one or more physical and chemical processes including, but not limited to, application of water, cleaning chemicals such as detergents, and mechanical treatment of the surface by brush or spray washers, followed by rinsing with potable water. Sanitation of the fresh cut produce 8 may include, but is not limited to, refrigerating the produce, applying a hot water wash, brushing or scrubbing off soil and microorganisms, or use of chlorine, hypochlorite, chlorine dioxide, acidified sodium chlorite, bromine, iodine, quaternary ammonium compounds, acidic compounds with or without fatty acid surfactants, alkaline compounds, peracetic acid alone and in combination with fatty acids, hydrogen peroxide, or ozone. Other sanitation methods include the use of ionizing radiation from ⁶⁰Co, ¹³⁷Cs, or machine generated electron beams, or use of biocontrol agents to prevent growth of human pathogens on produce.

In the illustrated embodiment, the means for hydration 5 may include, for example, chlorinated water to provide in-situ hydration to the fresh cut produce 8. As used herein, the term “chlorinated water” refers to water containing chlorine (Cl₂) or hypochlorite (ClO⁻). The chlorinated water will hydrate the fresh cut stems throughout the supply chain, preventing decay and keeping the produce fresh. Chlorine is known in the art of food processing as a means for sanitizing produce. The chlorinated water in the hydration medium will further prevent contamination of the fresh cut produce during transportation and handling. This embodiment is intended as only one example of how the fresh cut produce may be provided continuous hydration throughout the supply chain. Other methods may be used to provide in-situ hydration. Additives may include any combination of organic or inorganic chemical material that preserve freshness and delay decay such as a combination of citric acid, sugar, and bleach. The cut stems 7 are placed standing upright in the means for hydration 5.

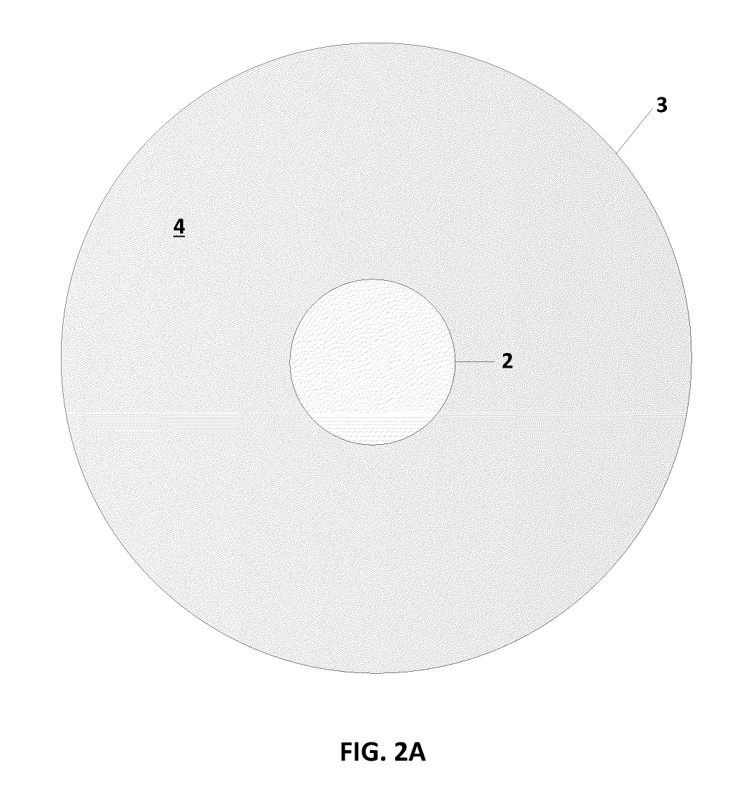

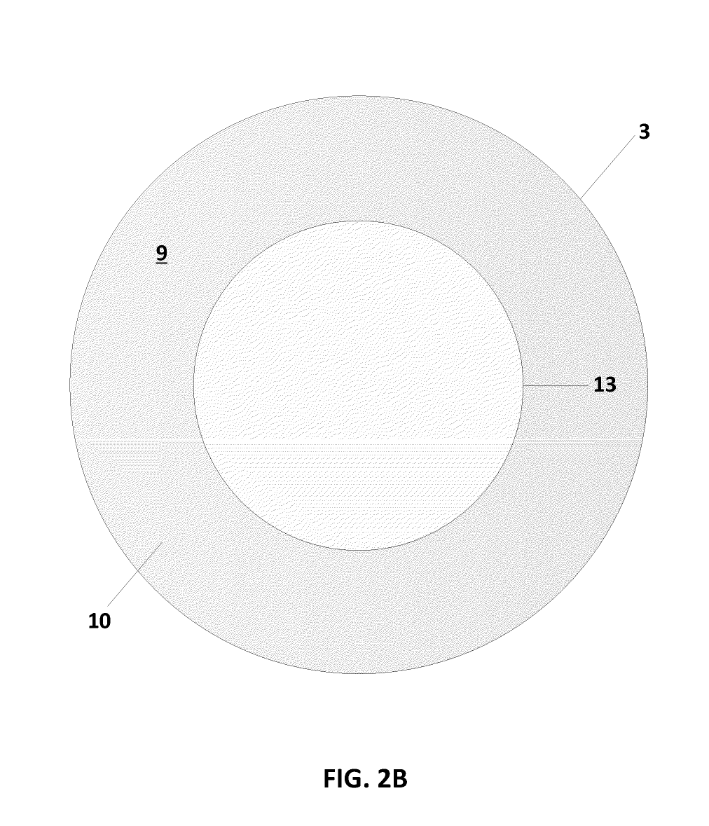

FIG. 2A a top view of the system 1 of FIG. In the illustrated embodiment, the system 1 includes a dome-shaped top 4. The dome shaped top 4 includes an aperture 2 and a lip 3. Although the illustrated embodiments show the aperture 2 in the dome-shaped top 4, the system 1 is not intended to be limited thereto. The aperture 2 may be located elsewhere on the dome-shaped top 4. In the illustrated embodiment, the aperture 2 is circular. In other embodiments, the dome-shaped top 4 may include a plurality of apertures of one or more shapes. The lip 3 is configured to mate tightly with the top rim 11 on the cup-shaped base 10 (not visible from this view).

FIG. 2B a bottom view of the system 1 of FIG. 1. In the illustrated embodiment, the system 1 includes a cup-shaped base 10. The cup-shaped base 202 includes a bottom 12 with side walls 9 extending upward to a top rim 11 (not shown in this view). The bottom 12 of the cup-shaped base 10 includes an outer, substantially flat surface 13. The substantially flat outer surface 13 is configured to prevent the system 1 from tilting and falling.

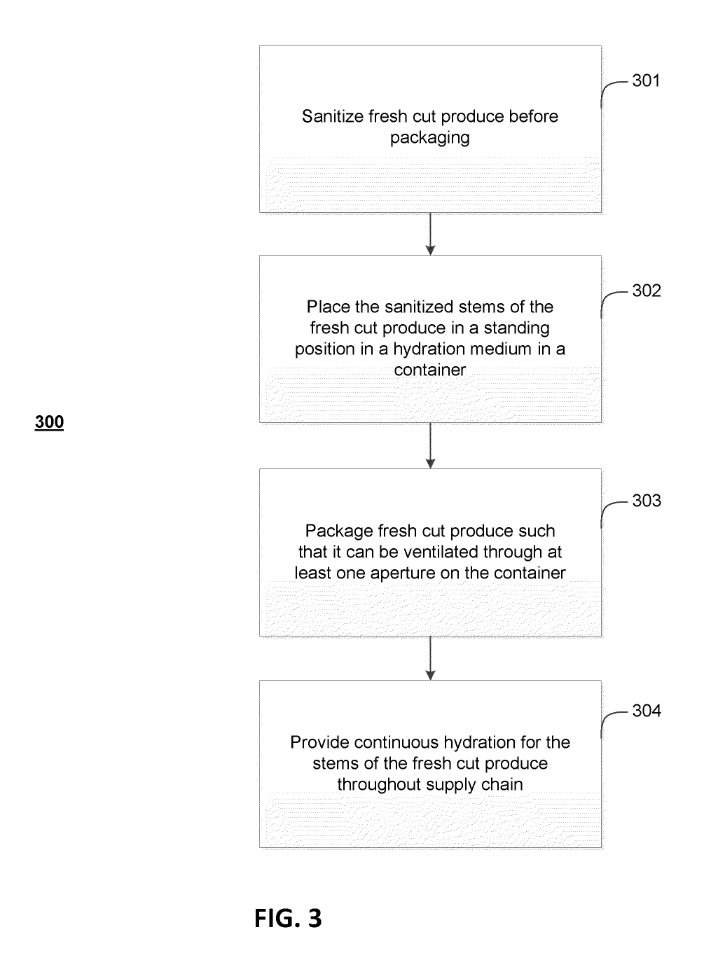

FIG. 3 is a flowchart illustrating an example method 300 for packaging and transporting fresh cut produce. The method includes a first step 301 of sanitizing the fresh cut produce before packaging. In the illustrated embodiment, the produce may be sanitized using a disinfectant or antibacterial wash or by spraying a peroxycompound. In other embodiments, the fresh cut produce may be sanitized using a chlorine bleach solution. The second step 302 includes placing the sanitized cut stems of the produce in a standing position in a hydration medium in a container. A third step 303 includes packing the produce such that it can be ventilated through at least one aperture on the container. A fourth step 304 includes providing continuous hydration for the cut stems throughout the supply chain with chlorinated water.

### Additional Embodiments

When the herbs stems are harvested by cutting them from the plant, physiological senescence sets in, leading to the loss of antioxidants and freshness. Thus, in some aspects of the present disclosure, a packaging system is disclosed that hydrates the harvested herb stems, keeping the physiology active and arresting senescence while in the retail packaging, enabling high post-harvest retention of antioxidants and preserving freshness.

In some aspects, a system is disclosed that incorporates in-situ hydration as a product such as cut herbs or cut produce or a cut stemmed plant goes through an entire supply chain in marketing. The system is new and different compared to existing methods of cut herb packaging for retail marketing. For example, current systems of packaging fresh cut herbs for retail marketing do not have a compact, convenient, and in-situ hydration system able to go through the entire supply chain in marketing. Therefore the current systems result in post-harvest loss of antioxidants, whereas embodiments of the disclosure are configured to enable high post-harvest retention of antioxidants.

In some embodiments, a clear transparent container is disclosed that enables customers to check visually the freshness and quality.

In some embodiments, an opening in a dome top is provided that allows ventilation and cooling as well as the essential oil aroma check by customers to confirm freshness.

In some embodiments, a non-tilt and non-spill design is provided that enables store display on table tops in non-refrigerated prime customer traffic locations.

In some embodiments, customer handling convenience is provided by the system design for placement of the device or system in a shopping cart and/or at home in a refrigerator.

In some embodiments, a method of using a system of the present disclosure is provided. The method includes pouring hydration medium into a container of the system, and placing harvested cut stems (herbs, produce, plants, etc.) in a standing position in the hydration medium.

In some embodiments, a method of using the system is provided. The method includes arresting physiological senescence and enabling post-harvest retention of antioxidants through use of a system disclosed in the present application.

In some embodiments, the method includes pre-sanitizing harvested herb stems (or produce stems or plant stems, etc.) before placing them inside a system or container of the present application.

In some embodiments, a container or system is configured to shelter edible herbs (or produce or non-edible plants) from contamination by touching and handling by store employees or shopping customers.

In some embodiments, a system is provided that functions throughout an entire supply chain from farm to home refrigerator.

In some embodiments, a method is provided that includes post-harvest retention of antioxidants in harvested herbs (edible plants or non-edible plants), with no preservatives or additives or chemical enhancements.

In some embodiments, a method of using a system disclosed in the present application is provided. The method enables natural (preservative free), post-harvest retention of antioxidants and freshness of harvested fresh cut edible herbs like basil (or other edible or non-edible plant), packaged for supermarket merchandizing.

In some embodiments, an eco-friendly wholesome method is provided to enable post-harvest retention of the antioxidants and freshness of harvested herbs like basil (or other herb or edible or non-edible plant), packaged for supermarket merchandizing, without any chemical preservatives or additives.

In some embodiments, a method includes in-situ hydration of each packaged unit,

In some embodiments, the method includes the ability of the hydration to continue to function throughout the supply chain transit in produce merchandizing from farm to customer home.

In some embodiments, a system is provided. The system is designed to individually package a fresh cut herb retail unit (or other fresh cut edible or non-edible plant retail unit) of a chosen size, for example 1.5 oz. In some embodiments, the retail unit is less than, greater than or about 0.1, 0.2, 0.3, 0.4, 0.5, 0.6, 0.7, 0.8, 0.9, 1.0, 1.1, 1.2, 1.3, 1.5, 1.6, 1.7, 1.8, 1.9, 2.0, 2.1, 2.2, 2.3, 2.4, 2.5, 2.6, 2.7, 2.8, 2.9, 3.0, 3.5, 4.0, 4.5, 5.0 oz. or between any of the aforementioned values.

In some embodiments, a system of FDA approved clear plastic is provided, which is configure to allow customers to see clearly the freshness and quality of the cut herbs (or cut produce or plants) inside.

In some embodiments, a container having a dome top is provided. The dome top has an opening in the top of a specific diameter, allowing some ventilation and cooling at the same time keeping some humidity within, while also allowing the customers to smell the essential oil aroma as a test for freshness.

In some embodiments, the container includes a flat bottom that enables the container to be placed on a store display table or inside a refrigerator standing up vertically keeping hydration medium inside without spilling.

In some embodiments, the container includes a compact packaging design that allows customers to conveniently place it in a shopping cart/shopping bag, and to conveniently place it inside a refrigerator.

In some embodiments, a method of using the container is provided. The method includes pouring a measured volume of hydration medium inside the container, placing harvested cut herb stems (or other edible or non-edible plants) standing in the medium and providing in-situ hydration.

In some embodiments, the method includes maintaining active physiology of fresh cut herb stems via in-situ hydration, providing additional shelf life in retailing, and providing additional post-harvest retention of antioxidants. One or more of these and other features of the method may provide increased and significant benefits to systems disclosed in the present application over existing systems known in the art.

In some embodiments, the method includes sanitizing harvested herb stems (or other edible or non-edible plant stems) with FDA approved methods before placing them inside a container disclosed in the present application.

Some embodiments of the present disclosure are configured to provide protection from microbiological contamination within a container. Herbs (or other edible or non-edible plants) inside the container are protected from touching/handling by store employees or customers, which keeps the herbs both clean and hygienic.

In some embodiments, a system is provided that provides hydration to cut herbs (or other edible or non-edible plants) in transit through an entire marketing supply chain to prevent physiological senescence.

In some embodiments, a method for post-harvest retention of antioxidants in certain herbs, with no preservatives, additives or chemical enhancements is provided.

In some embodiments, a container is provided. The container is configured to allow for a visual quality check, a, ventilation and aroma check, and customer handling convenience. The container also may include a non-tilt and non-spill design. In some embodiments, the container is further configured to allow for in-situ hydration to keep physiology alive and arrest senescence for cut herbs (or other edible or non-edible plants). In some embodiments, the container is further configured to protect cut herbs (or other edible or non-edible plants) from microbial contamination. In some embodiments, the container is configured to package the cut herbs (or other edible or non-edible plants) throughout an entire supply chain in marketing from farm to home refrigerator, without chemical enhancements.

One or more systems of the present disclosure are configured to preserve freshness and enable post-harvest retention of antioxidants of fresh cut herbs, (or other edible or non-edible plants) even while in transit through the entire supply chain in herb marketing, from farm to a customer's home refrigerator.

One or more methods of the present disclosure can be used to preserve antioxidants in fresh cut herbs (or other edible or non-edible plants) throughout an entire supply chain in marketing from farm to home refrigerator, without chemical enhancements.

One or more systems of the present disclosure are configured to be applicable to or be adapted to marketing any harvested plant products where senescence-caused loss of antioxidants is preventable with post-harvest hydration.

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Additionally, all references disclosed herein are hereby expressly incorporated by reference in their entireties.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system for packaging and transporting produce, comprising:
a cup-shaped base having a bottom with side walls extending upward therefrom to a top rim, the bottom having an outer substantially flat surface and an inner surface opposite the outer surface, and the inner surface and side walls forming an inner space;
means for hydration placed within the inner space to provide in-situ hydration to produce; and
a substantially dome-shaped top configured to rest upon and mate with the top rim.

2. The system of claim 1, wherein the means for hydration is chlorinated water or water having a chloramine level between about 0.50 ppm and about 3.80 ppm, and wherein the means for hydration further comprises one or more additives.

3. The system of claim 2, wherein the one or more additives are selected from the group consisting of citric acid, sugar, bleach, bactericides, fungicides, precipitation agents, surfactants, and substrates that can be metabolized.

4. The system of claim 1, wherein the means for hydration is soil or an absorbent non-organic material.

5. The system of claim 4, wherein the absorbent non-organic material is a water-soaked brick or mass, Rockwool or Canadian moss.

6. The system of claim 4, wherein the means for hydration further comprises chlorinated water or water having a chloramine level between about 0.50 ppm and about 3.80 ppm.

7. The system of claim 1, wherein the top rim is substantially circular.

8. The system of claim 1, wherein the side walls extend upward from the bottom in an angled fashion such that the inner space is smaller at the bottom and larger at the top rim.

9. The system of claim 1, wherein at least one of the cup-shaped base and the substantially dome-shaped top is formed of plastic.

10. The system of claim 1, wherein the substantially dome-shaped top includes an aperture.

11. The system of claim 1, wherein the substantially dome-shaped top has a top lip and the top rim has a bottom lip such that the top lip mates with the bottom lip.

12. The system of claim 1, wherein the produce is selected from the group consisting of flowers, basil, bay leaves, chives, cilantro, dill, lemongrass, marjoram, mint, oregano, parsley, rosemary, sage, tarragon, and thyme.

13. A container to package and transport sanitized produce, comprising:
a substantially cylindrical bottom with a flat base to allow it to stand vertically;
a dome top comprising an aperture fitted tightly over the bottom; and
a hydration medium positioned inside the container,
wherein the hydration medium uses chlorinated water to provide in-situ hydration.

14. The container of claim 13, wherein either the substantially cylindrical bottom or the dome top is formed of a clear plastic material.

15. The container of claim 13, wherein the aperture on the dome top has a diameter between about 2 cm and about 2.5 cm.

16. The container of claim 13, wherein the hydration medium is between about 1.5 cm and about 2.5 cm in thickness.

17. The container of claim 13, wherein the diameter of the substantially cylindrical bottom varies in a transverse direction such that the diameter is greatest at the top of the cylindrical bottom and smallest at the base.

18. A method for packaging and transporting produce while retaining antioxidants and freshness, comprising:
placing stems from fresh cut produce in a standing position in a hydration medium in a container having a bottom portion with a substantially flat surface and a top portion;
attaching the top portion to the bottom portion;
allowing the stems from fresh cut produce to be ventilated through an aperture on the top of the container; and
providing continuous hydration for the stems from fresh cut produce throughout the supply chain,
wherein the continuous hydration is provided with chlorinated water to provide in-situ hydration.

19. The method of claim 18 further comprising spraying the stems with a peroxycompound.

20. The method of claim 18, wherein placing the stems in a standing position comprises placing the stems in a hydration medium that has a thickness between about 1.5 cm and about 2.5 cm.
